(19) United States
(12) Patent Application Publication
(10) Pub. No.: US 2025/0037068 A1
(43) Pub. Date: Jan. 30, 2025

(54) INTERACTIVE DELIVERY

(71) Applicant: Tevva Motors Ltd, Essex (GB)

(72) Inventor: Asher Bennett, Tilbury (GB)

(21) Appl. No.: 18/715,687

(22) PCT Filed: Dec. 1, 2022
(86) PCT No.: PCT/GB2022/053038

§ 371 Date: May 31, 2024

(30) Foreign Application Priority Data
Dec. 1, 2021 (GB) 2117337.2

(51) Int. Cl. G06Q 10/0833; B60W 60/00; G07C 9/00; G07C 9/32

(52) U.S. Cl. CPC G06Q 10/0833; B60W 60/00256; G07C 9/00896; G07C 9/32; G07C 2009/0092

(57) ABSTRACT

In a first aspect, this specification describes a method for enabling self-service delivery, and which comprises: responsive to determining that a first predetermined condition relating to relative locations of a delivery vehicle and a first delivery location is satisfied, sending, to a user associated with the first delivery location, a first message offering a self-service delivery option; receiving, from the user in response to the first message, an indication of a user selection of the self-service delivery option; responsive to receiving the indication: sending, to the user, a second message comprising information relating to accessing a securable compartment from among plural securable compartments associated with the delivery vehicle; and issuing a message to cause an item associated with the user to be loaded into the securable compartment.

### FIELD

This specification relates to interactive delivery.

### BACKGROUND

In some instances, vehicles require human operation to function. In other instances, vehicles may be capable of operating autonomously some or all of the time. Autonomous capabilities can be provided for vehicles through a number of different known technologies.

When delivering packages, delivery personnel may use a delivery vehicle which can carry a large number of packages to be delivered. To fulfil a delivery, the delivery personnel may travel to and park their vehicle at a location close to the delivery destination (i.e. within walking distance of the destination). The delivery personnel may then retrieve, from the vehicle, one or more packages to be delivered to the destination, and carry, on foot, the one or more packages to the destination. To fulfil further deliveries, the delivery personnel may then return to their vehicle and repeat this process.

Some operators offer self-service delivery options to their customers. Traditional self-service delivery involves the operator delivering packages to for instance a locker in a communal space, which the customer can then pick up their package from when convenient. The customer may have to provide some sort of authentication in order to be granted access to their packages.

### SUMMARY

In a first aspect, this specification describes a method for enabling self-service delivery, and which comprises: responsive to determining that a first predetermined condition relating to relative locations of a delivery vehicle and a first delivery location is satisfied, sending, to a user associated with the first delivery location, a first message offering a self-service delivery option; receiving, from the user in response to the first message, an indication of a user selection of the self-service delivery option; responsive to receiving the indication: sending, to the user, a second message comprising information relating to accessing a securable compartment from among plural securable compartments associated with the delivery vehicle; and issuing a message to cause an item associated with the user to be loaded into the securable compartment.

The method may comprise determining that a second predetermined condition relating to relative locations of the first delivery location and a second delivery location is satisfied; and responsive to determining that the second predetermined condition is satisfied, sending, to the user associated with the first delivery location, a third message comprising data indicative of a collection location.

The method may further comprise causing the delivery vehicle to remain stationary proximal to the first delivery location or the second delivery location until it has been determined that the item associated with the user has been removed from the securable compartment.

The method may further comprise causing the delivery vehicle to autonomously travel from the second delivery location towards the first delivery location; and responsive to a third predetermined condition relating to relative locations of the delivery vehicle and the user and/or the first delivery location being satisfied, causing the delivery vehicle to park and remain stationary until it has been determined that the item associated with the user has been removed from the securable compartment.

The method may further comprise receiving a request to allow access to the securable compartment; and causing the securable compartment to allow access. The information providing access to the securable compartment may comprise authentication information associated with the user. The method may further comprise accessing stored authentication information associated with the user. Receiving the request to allow access to the securable compartment may comprise receiving authentication information; and determining that the received authentication information matches the authentication information associated with the user. The method may further comprise, responsive to determining that the received authentication information does not match the authentication information associated with the user, preventing the securable compartment from allowing access.

Allowing access to the securable compartment may comprise at least one of: opening a door of the securable compartment, unlocking a door of the securable compartment, and dispensing an item associated with the user.

Issuing the message to cause the item associated with the user to be loaded into the securable compartment may comprise providing an instruction, to an operator of the delivery vehicle, to load the item associated with the user into the securable compartment.

The method may comprise a determination step wherein if it is determined that there is no available suitable securable compartment on the vehicle for the item to be loaded into, the first message offering a self-service delivery option is not sent.

The message to cause an item associated with the user to be loaded into the securable compartment may be issued to a means for autonomously loading the item into the securable compartment.

In a second aspect, this specification describes a method performed by one or more user devices of a user associated with a first delivery location in a self-service delivery process, the method comprising: receiving a first message indicative of a predetermined condition relating to relative locations of a delivery vehicle and a first delivery location being satisfied, the first message offering a self-service delivery option; sending, in response to receiving the first message and a user input indicating a user selection of the self-service delivery option, an indication of the user selection of the self-service delivery option; and receiving a second message comprising information relating to accessing a securable compartment from among a plurality of securable compartments of the delivery vehicle.

The method may comprise, responsive to determining that the securable compartment is proximal, sending at least some of the received information relating to accessing the securable compartment.

In a third aspect, this specification describes a method comprising causing an item associated with a user to be loaded into a securable compartment from among plural securable compartments associated with a delivery vehicle, the delivery vehicle being configured to (i) be human operable and (ii) not carry additional passengers; causing the delivery vehicle to travel to a delivery location associated with the user; causing the securable compartment to allow collection of the item by the user.

In a fourth aspect, this specification describes a delivery vehicle comprising one or more securable compartments for containing an item to be delivered, the delivery vehicle comprising means to perform any method described with reference to the first aspect.

In a fifth aspect, this specification describes a user device comprising means to perform any method described with reference to the second aspect.

In a sixth aspect, this specification describes a computer-readable storage medium comprising instructions which, when executed by one or more processors, cause the one or more processors to perform any method described with reference to the first or second aspects.

In a seventh aspect, this specification describes a system comprising means to perform any method described with reference to the first or second aspects.

### BRIEF DESCRIPTION OF THE FIGURES

For a more complete understanding of the methods, apparatuses and computer readable instructions described herein, reference is now made to the following description taken in connection with the accompanying Figures, in which:

FIG. 1 illustrates an example of a self-service delivery system;

FIG. 2A illustrates an example of a vehicle used in the self-service delivery system;

FIG. 2B is a schematic diagram illustrating an example of a securable compartment used in the self-service delivery system;

FIG. 3 illustrates an example of a scenario in which the self-service delivery system is used;

FIG. 4 is a flow chart illustrating an example of a method performed by the vehicle in the self-service delivery system;

FIG. 5 is a flow chart illustrating an example of a method performed by the user device in the self-service delivery system; and

FIG. 6 is a schematic illustration of an example configuration of a computer system utilised to provide one or more of the operations described herein.

### DETAILED DESCRIPTION

In the description and drawings, like reference numerals may refer to like elements throughout.

This application describes systems and techniques for providing a self-service delivery system. In this context, self-service deliveries involve a recipient retrieving their item (which can also be termed a package) from a securable compartment on a delivery vehicle.

In an example, initially during delivery, items are by default designated for regular delivery (i.e. hand delivered by the driver) and thus are not loaded into securable compartments for interactive, or otherwise termed, self-service delivery. Then, responsive to a first predetermined condition relating to relative locations of the delivery vehicle delivering the items and the delivery location of a particular item being satisfied, the recipient of the particular item is offered a self-service type delivery via the transmission of a first message to the recipient. For instance, the first predetermined condition could be that the delivery vehicle is within a certain distance or a certain journey time of the delivery location, or that the delivery vehicle is a certain number of stops away from the delivery location.

If the user responds positively to the first message, thereby accepting the self-service delivery option, the user is sent a second message comprising information relating to accessing the securable compartment in which their item is or will be stored. For instance, the information may comprise a securable compartment identifier (e.g. a number) and a pass code. It may alternatively comprise just a pass code, or an identifier specific to the item.

In addition, a message is issued to cause the item to be loaded into the securable compartment. For instance, the operator of the delivery vehicle may receive an instruction to load the item into the securable compartment at their next stop.

In this way, users of the self-service delivery system are enabled to go to the delivery vehicle and retrieve their parcel without interfacing with the operator of the delivery vehicle. The system also allows operators of delivery vehicles to complete deliveries without having to hand-deliver or otherwise interface with users for every delivery.

This system therefore reduces resource expenditure (e.g. fuel, man hours, financial cost) in completing deliveries to users that are prepared to collect their items from the delivery vehicle rather than have delivery to the door. This in turn increases the number of deliveries per delivery vehicle per day, reducing congestion by reducing the number of vehicles on the road and reducing dwell time (dwell time being the time for which a delivery vehicle is stopped at a location).

Although the system is generally described in relation to self-service delivery, it will be appreciated that the system may also be used in self-service sending of items. For instance, when a user is collecting an item from a securable compartment on a vehicle during a self-service delivery procedure, or otherwise, they may engage in a self-service sending procedure by loading an item into a securable compartment on the vehicle. For instance, the first messages and second messages described herein may relate to self-service sending rather than, or in addition to, self-service delivery.

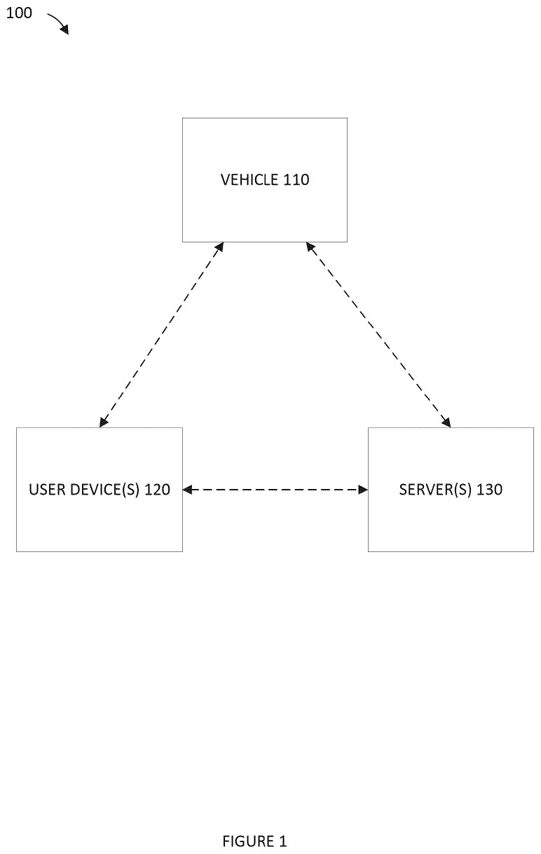

FIG. 1 illustrates an example of a self-service delivery system 100. The self-service delivery system 100 includes a delivery vehicle 110 and one or more user devices 120. In some examples, the vehicle relocation system 100 also includes one or more servers 130.

The vehicle 110 can be any type of vehicle which is self-propelled, for instance, the vehicle 110 may be self-propelled by one or more of an electric motor and/or an internal combustion engine. The vehicle 110 may be powered by any suitable power source, for instance, battery, petrol, diesel, hydrogen fuel cell, etc. In some examples, the vehicle 110 may be capable of autonomously travelling to a target location without human supervision. Additionally or alternatively, the vehicle 110 may be capable of being controlled by a human.

The vehicle 110 may be a motor vehicle, e.g. an automobile, a van, a truck, a lorry, a bike, a trike, a bus, etc. In some examples, the vehicle 110 may be configured to operate on public roads. For instance, the vehicle 110 may be a delivery vehicle capable of carrying packages. In some other examples, the vehicle 110 may be configured to operate in environments other than public roads, such as airports, sea or river ports, construction sites, etc. For instance, the vehicle 110 may be a baggage tug at an airport.

Alternatively, the vehicle 110 may be, for instance, a baggage cart, a trolley, etc. Alternatively, the vehicle may be a watercraft (e.g. a boat, a barge, etc.), an amphibious vehicle, or an aircraft (an airplane, a helicopter, a quad-copter, etc.).

As mentioned, the vehicle 110 may be capable of both human/user controlled operation and autonomous operation. For instance, the vehicle 110 may be capable of entering, from a human-controlled mode in which the vehicle 110 operates under human control, to an autonomous mode in which the vehicle 110 operates autonomously, i.e. without human control, and vice versa. Switching between these modes may be responsive to a user input. The human controlled operation involves the user being physically present inside of the vehicle 110 to operate its controls. The autonomous mode may allow for the vehicle 110 to be empty, or, in other words, for no humans to be inside the vehicle 110 during autonomous mode operation.

The user device(s) 120 can include any type of computing device which can provide one or more of the operations described herein. For instance, the user device(s) can comprise a desktop computer, a laptop, a tablet, a smart phone, a PDA, an MP3 player, a smart watch, a wearable device, a smart TV, a smart speaker, etc.

Messages sent to the user may be sent directly to one or more of the user device(s) 120 belonging to the user. For instance, a message directed to the user may be sent via an SMS message to a phone number associated with the user, and be received directly by a mobile phone associated with the phone number. Additionally or alternatively, messages sent to the user may be sent to addresses (e.g. email addresses) known to be accessible to the user. Additionally or alternatively, messages sent to the user may be sent to an account known to be accessible to the user or otherwise associated with the user, for instance for output by a software application running on a smartphone and for which the user is logged in. Similarly, messages sent from the user may be sent directly from a particular user device 120, via an address associated with the user, and/or via an account associated with the user.

The one or more servers 130 comprise computing resources remote from the vehicle 110 and the user device 120. In some examples, one or more of the operations described herein may be performed by the one or more servers 130.

The one or more servers 130 may be in communication with the vehicle 110 and/or the user device 120. For instance, the server 130 and the vehicle 110 and/or the user device 120 are connected to a wireless network. For instance, the wireless network may be a cellular network. In some examples, one or more communications between the vehicle 110 and the user device 120 may be delivered via the one or more servers 130.

Additionally or alternatively, the vehicle 110 and the user device 120 may be in direct communication. In some examples, the vehicle 110 and the user device 120 may be connected to a local wireless network. For instance, the local wireless network may comprise a Bluetooth network, a Wi-Fi network, a ZigBee network, etc. In some examples, the vehicle 110 and the user device 120 may communicate directly, for instance via infrared messages, radio messages, etc.

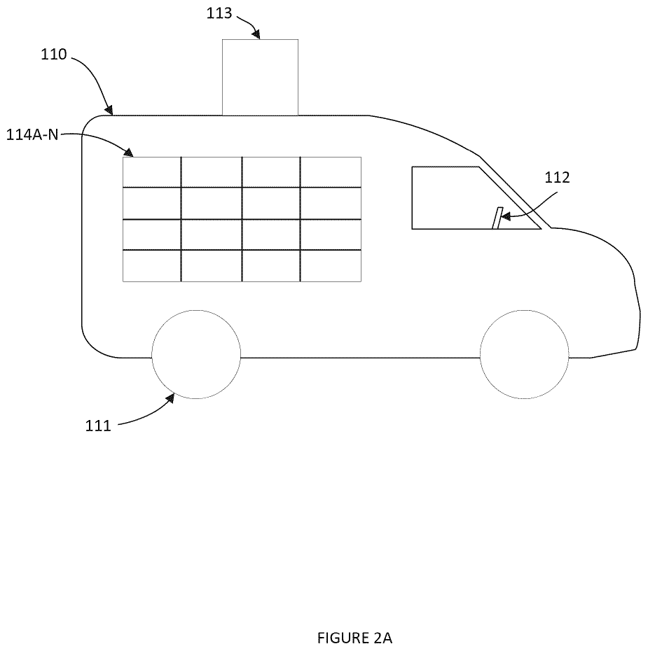

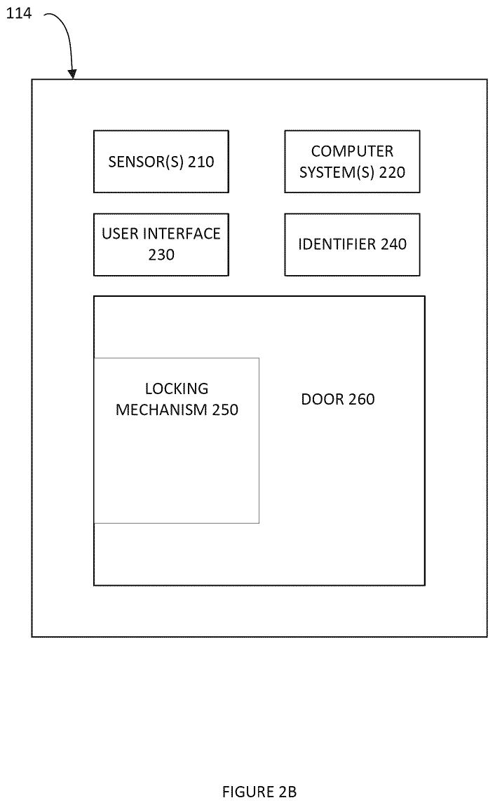

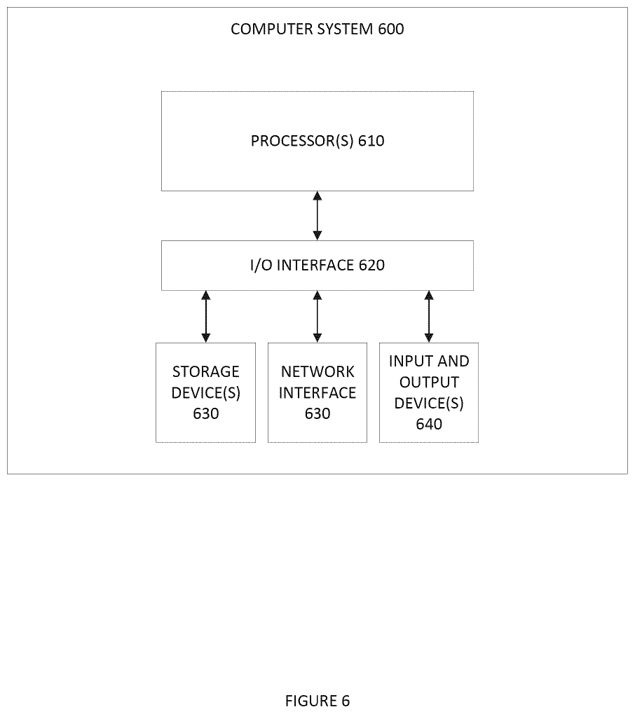

FIG. 2A illustrates an example of a vehicle used in the self-service delivery system. The vehicle 110 illustrated in FIG. 2A comprises wheels 11, a steering wheel 112, one or more sensors 113, a plurality of securable compartments 114A to 114N, and one or more computer systems (discussed below with reference to FIG. 6).

Although the vehicle 110 illustrated in FIG. 2 is a motor vehicle, it will be appreciated that the vehicle 110 is not limited to this, as discussed above. As such, although the vehicle 110 is illustrated as comprising wheels 111 in FIG. 2, the vehicle is not limited to this and may comprise any means of propulsion (e.g. tracks, propellers, etc.). In addition, although the vehicle 110 is illustrated as comprising a steering wheel 112, the vehicle in may comprise any means of vehicle control (e.g. button-type electrical switch, touch-sensitive display, levers, pedals, etc.).

In examples in which the vehicle 110 comprises autonomous driving capabilities, the vehicle 110 may comprise sensors 113 which may comprise any type of sensors usable for autonomous driving capabilities. For instance, the sensors 113 may comprise one or more of an optical camera, a LIDAR, a stereo vision sensor, GNSS (e.g. GPS or Galileo), an IMU, infrared sensor, a roof mounted camera system, etc.

The computer systems of the vehicle 110 may be used to provide one or more operations discussed herein. The computer systems may comprise one or more means capable of communicating with the user device 110 and/or the servers 130.

In examples in which the vehicle comprises autonomous driving capabilities, these may be provided by the computer systems of the vehicle 110. For instance, the computer systems may operate the steering wheel 112 and/or any other vehicle control means based on sensor data from the sensors 113, to control the wheels 111 of the vehicle 110 and thus autonomously travel from a first location to a second location.

The vehicle 110 may further comprise one or more output devices for providing instructions to an operator of the vehicle 110. For instance, the vehicle 110 may comprise a display and/or a speaker. As an example, the operator of the vehicle 110 can be provided with an instruction, via an output device of the vehicle, to load a particular item into a particular securable compartment 114A to 114N. Additionally or alternatively, the operator of the vehicle 110 may be provided with instructions via a device (e.g. a mobile device, a smart phone, a tablet) in communication with the vehicle 110 or the servers 130.

The vehicle 110 may comprise means to autonomously load items into the securable compartments 114A to 114N. For instance, the vehicle 110 may comprise a robotic arm (not shown) capable of autonomously loading an item into a securable compartment 114A to 114N. The means may autonomously load items into the securable compartments 114A to 114N responsive to a message being issued to cause a particular item to be loaded into the securable compartment.

At least some of the securable compartments 114A to 114N may be arranged on an external of the vehicle 110. The securable compartments 114A to 114N are discussed in more detail below with reference to FIG. 2B.

FIG. 2B is a schematic diagram illustrating an example of a securable compartment used in the self-service delivery system. The securable compartment 114 illustrated in FIG. 2B comprises one or more securable compartment sensors 210, one or more computer systems 220 (discussed below with reference to FIG. 6), a user interface 230, an identifier 240, a locking mechanism 250, and a door 260.

As an example, the computer system 220 of the securable compartment 114 can determine that sensor data from the securable compartment sensors 210 is indicative of a legitimate request to access the securable compartment 114. Responsive to this determination the computer system 220 can operate the locking mechanism 230 to enable access to the securable compartment (e.g. by unlocking the door or opening the door), so that the user can retrieve their package. In some examples, the securable compartment may be configured to, responsive to determining that the user is authenticated and/or that the request is legitimate, dispense the item to the user. This functionality may be provided by any suitable means.

In some examples, authentication is not required, so one or more of the sensor(s) 210, the computer system 220, the user interface 230, and the locking mechanism 250 are not provided. In these examples, a user can be provided access to the securable compartment 114 by action of opening the door 260 (e.g. by operating a door handle).

In examples where authentication is required, the authentication information can be retrieved from the sensor(s) 210, the user interface 230, or both. Additionally or alternatively, the user can be authenticated by virtue of the location of the user (e.g. determined based on a wireless signal from the user device 120 associated with the user and which may be assumed to be being carried by the user), the location of the vehicle 110, the relative location of the user and the vehicle 110, the current time, etc. It will be appreciated that where the sensor(s) 210 and/or the user interface 230 are not used in providing authentication information, they may not be provided with the securable compartment 114.

In addition, a set of the sensors 210, the user interface 230, and/or the computer system 220 may be provided for each securable compartment 114, for a subset of the securable compartments 114, or for all of the securable compartments 114 provided on the vehicle 110.

The sensor(s) 210 can comprise any sensors capable of fulfilling one or more of the operations described herein. For instance, the sensor(s) 210 may comprise an optical camera, a barcode reader, an RFID reader, an NFC reader, a fingerprint scanner, a Bluetooth transceiver, etc.

The sensor(s) 210 may be configured to detect authentication information, for instance biometric information of the user (e.g. fingerprint, face, retinal pattern, etc.) and/or from the user's device 120 (e.g. QR code, barcode, a key, a password, a passcode, etc.). The sensor data from the sensor(s) 210 may then be provided for comparison against known authentication information in order to authenticate the user. Once the user has been authenticated, they may be provided with access to the securable compartment 114 to retrieve their item.

In this way, the self-service delivery system can ensure a high level of security, so that persons other than the user associated with the item in the securable compartment 114 are prevented from accessing the item.

The sensor(s) 210 may be configured to detect the presence of an item in the securable compartment, or otherwise to detect when an item has been loaded and/or retrieved from the securable compartment. The sensor(s) 210 may also be configured to detect the current status of the door 260 and/or locking mechanism 250. For instance, the vehicle 110 may be prevented from travelling whilst one or more doors 260 are determined to be open.

The user interface 230 may be, for instance, a touch-sensitive display, a keypad, a microphone and/or speaker, etc.

The user interface 230 may be configured to receive, via user input, authentication information. For instance, the authentication information provided via user input may comprise a password, a pass code, a personal identification number, etc. The authentication information received via user input at the user interface 230 may then be provided for comparison against known authentication information in order to authenticate the user. Once the user has been authenticated, they may be provided with access to the securable compartment 114 to retrieve their item.

The user interface 230 may be configured to provide information to the user. For instance, the user interface 230 may communicate instructions to the user in the retrieval of their item (e.g. “type in the password”, “present the QR code”, “present face to the camera”, etc.). The user interface 230 may also communicate information relating to the progress and/or status of the self-service delivery process (e.g. “wrong password”, “unlocking door”, “wrong securable compartment”, etc.).

The identifier 240 can be of any form suitable to indicate an identity of a particular securable compartment 114. For instance, the identifier 240 may be displayed on a display or may be printed or painted on to the particular securable compartment 114 to which it relates. The identifier 240 may be for instance, a number, a name, a colour, an LED configured to illuminate when the user requests access to the securable container 114, etc.

The locking mechanism 250 can be of any form suitable to switch between a locked state in which the locking mechanism 250 holds the door 260 in a closed position thus preventing access, to an unlocked state in which the door 260 is not prevented from opening. The locking mechanism 250 may be electronically operated by the computer system 220 of the securable compartment 114. For instance, the locking mechanism 250 may be caused to prevent access to the securable compartment 114 until a user attempting to access the securable compartment 114 has been authenticated.

The door 260 is configured to secure the securable compartment 114 so that, when the door 260 is in a closed position, items placed inside of the securable compartment 114 are contained within the securable compartment 114. The door 260 is configured to move from the closed position to an open position, in which items can be loaded in to and retrieved from the securable compartment 114.

The door 260 may be operated to move from the closed position to the open position (and vice versa) by user input. For instance, the securable compartment 114 may comprise a handle or a button which causes the door 260 to open (and/or close). Additionally or alternatively, the door 260 may be operated electronically, e.g. by the computer system(s) 220. For instance, the door 260 may be caused to automatically open once the user has been authenticated. The door 260 may be sprung so that it opens when the locking mechanism 250 is released. In some examples, the door 260 may be a roller type door, which may be configured to be electronically operated to open and/or close by rolling and/or unrolling respectively.

In some examples, the securable compartment 114 comprises a first door for loading the securable compartment 114 and a second door for retrieving items from the securable compartment 114. For instance, the first door may be accessible externally from the vehicle 110 and the second door may be accessible from an internal of the vehicle 110 (e.g. from a cargo area).

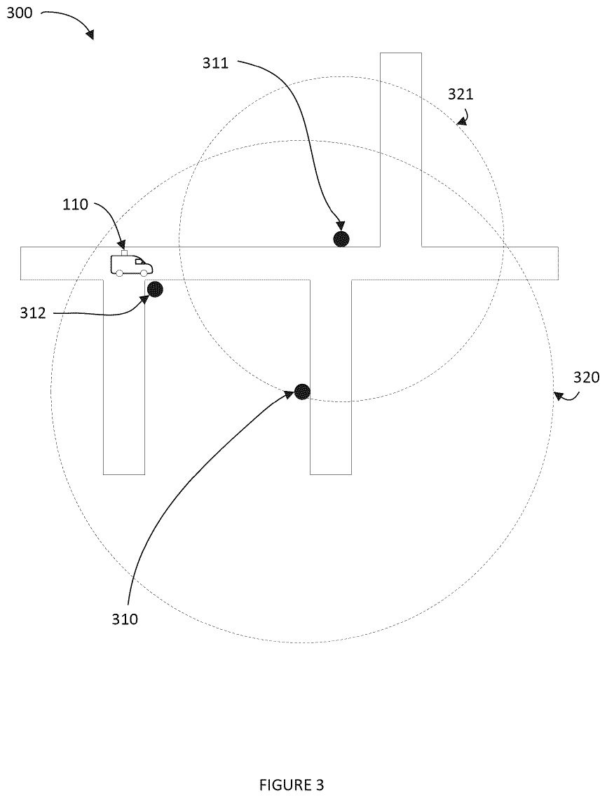

In some examples, the securable compartment 114 may form part of an autonomous delivery robot which is carried by the vehicle 110. The autonomous delivery robot may be configured to autonomously travel to a target location (e.g. a delivery location associated with one or more users, or another location as discussed below in relation to FIG. 3) without human supervision, after the driver has loaded the respective one or more items into the securable compartment 114. The autonomous delivery robot may be configured to release the item from the securable compartment 114 at the target location by any suitable means, or may be configured such that a human is required to retrieve the item (e.g. if authentication is required).

FIG. 3 illustrates an example of a scenario in which the self-service delivery system is used.

As shown in FIG. 3, the vehicle 110 is approaching a first stop 312. For instance, the first stop 312 may be at or near to a location to which an item carried by the vehicle 110 is to be delivered to.

As also shown in FIG. 3, the vehicle 110 is within a predefined threshold distance 320 of a location associated with a particular user (e.g. their home, their office building, or a car park near their home or office building). The location associated with the user may be called the first delivery location 310.

Once the vehicle 110 has entered the predefined threshold distance 320 of the first location 310, the user is sent (e.g. by the vehicle 110 or the server 130) a first message offering a self-service delivery option. In some examples, the first message may allow the user to confirm a previous selection of a self-service delivery option (e.g. at time of ordering). In addition, or alternatively, the first message may be the first time that the user has been offered a self-service delivery option in relation to this item. The first message may comprise information indicative of the distance of the vehicle 110 from the first location, the time until the vehicle 110 is expected to arrive at the first location, the number of stops away, the location of the vehicle 110, etc.

If the user responds to the first message with a selection of the self-service delivery option, a message to cause an item associated with the user to be loaded into a securable compartment 114 is issued. For instance, an instruction may be provided to the operator of the vehicle 110 to load the item into the securable compartment 114. The operator may then, when they next park the vehicle 110, for instance at the first stop 312, the first delivery location 310, or the second delivery location 311, place an item from a cargo area of the vehicle 110 into the securable compartment 114.

The vehicle 110 may be caused to travel to the first delivery location 310 (e.g. autonomously or by instructing the driver to do so). The user may be instructed to collect their item from the vehicle 110 whilst at the first delivery location 310. A time limit may be set for the user to collect their item, where when the time limit expires the vehicle 110 may be caused to continue on its journey even if the user has not collected their item. The vehicle 110 may be caused to wait at the first delivery location 310 until the user has collected their item. The operator of the delivery vehicle 110 can therefore hand deliver to other nearby delivery locations whilst the vehicle 110 is parked at the first delivery location 310 and the user is collecting their item from the vehicle 110. In this way, the efficiency of item delivery can be increased.

In addition, a determination may be made as to whether the first delivery location is within a predefined threshold distance 321 of a second delivery location 311. The second delivery location 311 may be a stop scheduled for the vehicle 110 close to the first delivery location 310 (e.g. in distance, journey time, number of stops, etc.). For instance, the first delivery location 310 may be the location of the user's home or office building, and the second delivery location 311 may be a car park near the user's home or office building, or another user's home near the user's home, etc.

In this case, responsive to the user selecting a self-service delivery option, the vehicle 110 may be caused to travel to the second delivery location 311 without first travelling to the first delivery location 310.

In some examples, the vehicle 110 is then caused to park at the second delivery location 311. The user may be instructed to collect their item from the vehicle 110 whilst at the second delivery location 311. A time limit may be set for the user to collect their item, where when the time limit expires the vehicle 110 may be caused to continue on its journey even if the user has not collected their item. The vehicle 110 may be caused to wait at the second delivery location 311 until the user has collected their item from the vehicle 110.

In some examples, the vehicle 110 is caused to travel to and park between the first delivery location 310 and the second delivery location 311. This may allow users travelling from both the first delivery location 310 and the second delivery location 311 to easily walk to the vehicle 110 and retrieve their items. In this way, the distance which the vehicle 110 has to travel is reduced, reducing fuel consumption and congestion.

In some examples, a determination that a group of users (including the user associated with the first delivery location 310) within a certain proximity to one another (e.g. within walking distance) have selected a self-service delivery option is made. In this case, the vehicle 110 may be caused to travel to and park at a location convenient for each user in the group of users, e.g. the second delivery location 311. Each of the group of users may then be instructed to collect their respective items from the vehicle 110 whilst at the second delivery location 311. As an example, the group of users may live in a block of flats (also known as an apartment block) or be present in an office building, and the second delivery location 311 may be a carpark for or otherwise near (e.g. within a walking distance) the block of flats. Each user can then retrieve their item from the vehicle 110 whilst it is parked in the block of flats' or office building's carpark. In this way, a large number of items can be delivered simultaneously, further increasing the efficiency of package delivery.

In some examples, the location which the vehicle 110 is caused to travel to for the user to collect their item is based at least in part on improving an efficiency of the delivery route (and thereby reducing congestion, fuel expenditure, etc.). For instance, it may be determined that a location (e.g. the second delivery location 311) may contain a high density of recipients (e.g. because there are numerous recipients in a particular office building) as compared to another location (e.g. the first delivery location 310). As such, it may be determined that it is more efficient for the driver to hand-deliver items to recipients at the higher density location, and for the recipient at the lower density location to collect the item. The vehicle 110 may therefore be caused to travel to the higher density location. In addition, the recipient at the lower density location may therefore be instructed to travel to the vehicle to collect their item whilst the driver is hand delivering at the higher density location, or the vehicle may be caused to travel to the recipient at the lower density location. In examples in which the securable compartment 114 forms part of an autonomous delivery robot, the autonomous delivery robot may be caused to travel to the lower density location.

In some examples, the vehicle 110 is caused to travel autonomously from the second delivery location 311 to other delivery locations, which may include the first delivery location 310. For instance, the vehicle 110 may be caused to travel autonomously from the second delivery location towards the first delivery location 310. As another example, the driver of the vehicle 110 may approach the second delivery location 311, possibly because there are a number of hand deliveries which the driver must make at the second delivery location, and the vehicle 110 may be caused to autonomously travel to a suitable place to park in the surrounding area whilst the driver is completing the deliveries. The operator of the vehicle may hand deliver items (for instance, to a user located at the second delivery location 311) whilst the vehicle is autonomously travelling. In this way, the efficiency of item delivery can be improved further. The user may be instructed to collect their item from the vehicle no whilst it is autonomously travelling in an area close to the first delivery location 310. The vehicle no may be prevented from leaving an area close to the first delivery location 310 until the user has collected their item. The vehicle no may be caused to park responsive to a predetermined condition relating to relative locations of the vehicle no and the user, and/or the first delivery location being satisfied. For instance, the vehicle no may be caused to park when it is determined that the user is nearby or when the vehicle 110 is near the first delivery location. The vehicle no may further be caused to wait after parking until the user has collected their item.

The vehicle no may make the determination that it is within the predefined threshold distance 320. Additionally or alternatively, the servers 130 may make the determination that the vehicle no is within the predefined threshold distance 320. Similarly, the vehicle no and/or the servers 130 may determine whether the second delivery location 311 is within a predefined threshold distance 321 of the first delivery location 310. Although for ease of illustration, predefined distance thresholds are shown in FIG. 3, the satisfaction of other predetermined conditions may additionally or alternatively be determined. For instance, the vehicle no and/or the server 130 may determine whether the vehicle no is within a certain journey time or a certain number of stops.

In some examples, the user may be capable of cancelling the self-service delivery option. For instance, the user may be asked to confirm selection of the self-service delivery option at various times before the scheduled delivery time (or after e.g. whilst the vehicle no is waiting for the user to collect their item). If the user responds negatively (or e.g. does not respond positively within a predetermined threshold of time), the self-service delivery option may be cancelled. In this case, the operator of the vehicle no may be caused to hand-deliver the item, the vehicle no may not stop and wait for the user to collect their item, and/or if the vehicle 110 is already waiting for the user to collect their item, the vehicle 110 may be caused to cease waiting. In addition or alternatively, the user may be able to cancel the self-service delivery option without being prompted e.g. by sending a message or selecting an option indicative of cancelling the self-service delivery option of their own accord.

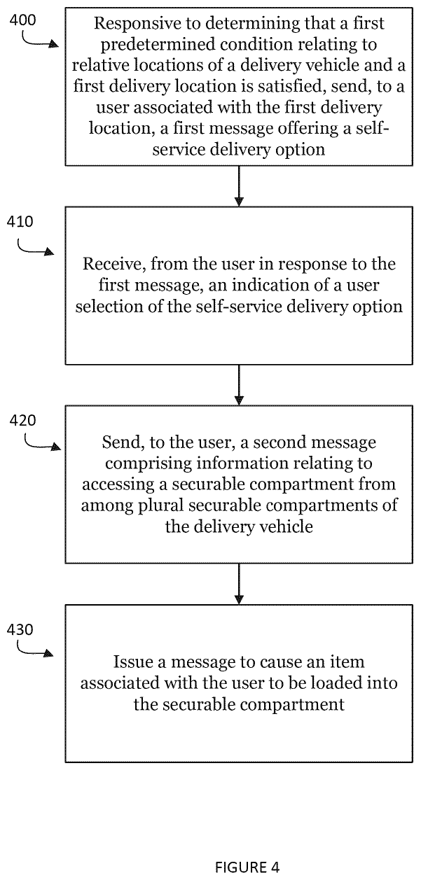

FIG. 4 is a flow chart illustrating an example of a method performed by the vehicle in the self-service delivery system. The operations may be performed by one or more of the computing systems of the vehicle 110. Additionally or alternatively, one or more of the operations may be performed by the servers 130.

At operation 40o, responsive to determining that a first predetermined condition relating to relative locations of a delivery vehicle 110 and a first delivery location is satisfied, the vehicle 110 sends, to a user associated with the first delivery location, a first message offering a self-service delivery option.

The first delivery location may be, for instance, the current location of the user, or a home address or office building address associated with the user, or a specified delivery address, as described above in relation to FIG. 3.

The first predetermined condition may comprise: the vehicle 110 being within a predefined threshold distance of the first delivery location, the vehicle 110 being within a predefined threshold journey time of the first delivery location, the vehicle 110 being within a predefined threshold number of scheduled stops of the first delivery location, etc., as described above in relation to FIG. 3.

The first message may be, for instance, a message sent to the user (e.g. via one or more of the user's devices 120) asking the user to perform a specific action to indicate a selection of the self-service delivery option (e.g. “respond yes to this message”). Additionally or alternatively, the message may include one or more interactive elements by which the user can indicate a selection of the self-service delivery option (e.g. a hyperlink, a checkbox, a slider, a radio button, etc.).

The first message may further comprise information relating to the location of the vehicle 110. For instance, the first message may comprise information indicative of the proximity of the vehicle 110 to the user and/or first delivery location (e.g. in distance, journey time, number of stops, etc.), and/or the current location of the vehicle 110 (e.g. shown on a map). As an example, the first message could include the text “Your delivery is 5 minutes away, would you like to select self-service delivery?”.

At operation 410, the vehicle 110 receives, from the user in response to the first message, an indication of a user selection of the self-service delivery option.

The vehicle 110 may receive the indication directly from the user (e.g. via the user device 120) or via the servers 130. In some instances, the indication is received by the operator of the vehicle 110 e.g. via a device belonging to the operator.

The indication may be, for instance, a message sent by the user, or an indication that the user has selected an interactive element present in the first message.

At operation 420, the vehicle 110, responsive to receiving the indication of the user selection of the self-service delivery option, sends, to the user, a second message comprising information relating to accessing a securable compartment from among plural securable compartments of the delivery vehicle.

In some examples, the second message comprises a confirmation that the self-service delivery option has been selected. As an example, the second message could include the text (“selection of self-service delivery confirmed”).

In some examples, the second message comprises information which can be used to identify the particular securable compartment 114 in which the item associated with the user has been loaded. For instance, the second message may comprise an indication of a name displayed on the particular securable compartment 114, a colour displayed on the particular securable compartment 114, a number displayed on the particular securable compartment 114, a location of the particular securable compartment 114 on the vehicle 110, a number plate/colour/make/model of the vehicle 110, etc.

In some examples, the second message comprises information which can be used to authenticate the user when they request access to the particular securable compartment 114. For instance, the second message may comprise a PIN number, a password, a passcode, a key, etc. The authentication information may be cryptographically secure. The authentication information may be time limited (e.g. only valid for 30 seconds), and/or limited to a certain number of uses (e.g. only valid for one use).

In some examples, the second message comprises information indicative of a pickup location, as described above in relation to FIG. 3. For instance, the second message may comprise coordinates, directions, a location shown on a map, etc. The second message may comprise information relating to the nature of the self-service delivery option (e.g. parking near the user's home, autonomously driving past the user's home). The second message may comprise instructions for the user to follow in the self-service delivery process (e.g. an indication of the arrival time of the vehicle 110 at the pickup location, an indication of when the vehicle 110 is estimated to autonomously travel near the user's home, an indication of the time by which the user needs to collect their item by before the vehicle 110 will continue with its journey, etc.).

In some examples, the second message comprises information relating to the location of the vehicle 110. For instance, the second message may indicate that the vehicle 110 is X minutes away, is X stops away, or is X metres away, etc. The second message may also provide an indication of the current location of the vehicle 110 (e.g. a location shown on a map).

In some examples, a plurality of second messages are sent. For instance, the user may be kept informed of the progress of the vehicle 110 as it approaches the pickup location by regular updates in second messages.

At operation 430, responsive to receiving the indication of the user selection of the self-service delivery option, the vehicle 110 issues a message to cause an item associated with the user to be loaded into the securable compartment.

Issuing the message to cause the item associated with the user to be loaded into the securable compartment may comprise providing an instruction, to an operator of the delivery vehicle, to load the item associated with the user into the securable compartment. The operator may be instructed to load the item into the securable compartment at a scheduled stop prior to a scheduled stop associated with the user. In addition or alternatively, the message may provide confirmation that an item previously loaded into a securable compartment should remain in the securable compartment. For instance, this may be when the user has previously selected the self-service delivery option (e.g. at time of ordering) and has subsequently confirmed the selection (e.g. in response to the first message).

In this way, the self-service delivery system can allow for more flexibility and convenience for the user as compared to, for instance, requiring the user to commit to self-service delivery at time of ordering and loading the item into the securable compartment at the base station. Since the self-service delivery option is offered to the user near a time which the delivery is to be completed (as compared to, for instance, when the user orders the item), the user can take into account up to date information when they make a decision to select and/or confirm the self-service delivery option.

For instance, the user can know that they are available to retrieve their item from the vehicle in the next 5 minutes and as a result can select the self-service delivery option, rather than committing to being available at a certain time in advance (e.g. when they order the item, or prior to the vehicle 110 departing from the base station). The window of time which the user should ensure that they are available to collect their item can also be minimised, since, as in the example above, they can be aware that the vehicle 110 is only e.g. 5 minutes away (as compared to selecting a self-service delivery option ahead of time e.g. at order time, where an estimated delivery time may be a much wider window of time).

In addition, as compared to loading the securable compartments at a base station, the self-service delivery system allows greater utilisation of the securable compartments 114. This is because the securable compartments can be used multiple times before the vehicle returns to the base station since the operator loads the securable compartments during their journey. In this way, the above mentioned advantages (e.g. of improved efficiency, reduced fuel consumption, reduced congestion) is compounded.

Furthermore, by determining to offer the self-service delivery option to the user near a time which the delivery to the user is to be completed, up to date information about the vehicle 110 may be taken into account when offering the self-service delivery option. For instance, if it is determined that there is no available suitable securable compartment 114 on the vehicle 110 for the item to be loaded into, the self-service delivery option may not be offered.

In some examples, the message is issued to a means for autonomously loading the item into the securable compartment 114. The means may comprise, for instance, a robotic arm, or a conveyor.

The method illustrated in FIG. 4 may further comprise the operations of the vehicle 110 receiving a request to allow access to the securable compartment and causing the securable compartment to allow access, as described above in relation to FIG. 2B.

Allowing access to the securable compartment 114 may comprise one or more of opening a door 260 of the securable compartment 114, unlocking a door 260 of the securable compartment 114, and dispensing the item.

Receiving the request to allow access to the securable compartment may comprise receiving authentication information, and determining that the received authentication information matches authentication information associated with the user.

The authentication information associated with the user may have been sent to the user in the second message (e.g. a password, a passcode, a PIN, a key, a QR code, a barcode etc.), and/or may be stored authentication information associated with the user which is retrieved from storage of the vehicle 110 and/or the servers 130 (e.g. a password, a passcode, a PIN, a key, a QR code, a barcode, a fingerprint, a retinal pattern, a face identifier, a voice identifier, etc.).

The received authentication information may be received via the sensors 210 of the securable compartment 114 and/or the user interface 230 of the securable compartment.

As an example, a QR code is sent to the user in the second message. The user can then display the QR code on a display of their user device 120, and present this to a camera on the securable compartment 114. The camera of the securable compartment 114 detects the QR code, and the detected QR code (or information stored therein) is then compared to the QR code (or information stored therein) to the QR code sent to the user in the second message. If the QR codes (or the information stored therein) are determined to match, the user is authenticated. The user is thus provided access to the securable compartment (e.g. by the door 260 being unlocked). In some examples, multiple types of authentication may be required. For instance, as in the example above, the user may be required to present a QR code, however, they may additionally be asked to, for instance, enter a password or provide a biometric identifier (e.g. via facial recognition or finger print scanning) to be considered authenticated. By making use of multi-factor authentication in this way, security can be further increased.

If it is determined that the received authentication information does not match the authentication associated with the user, the user is not authenticated. In this case, it is deemed that a legitimate request to allow access to the securable compartment 114 has not been received. As such, the user is not provided with access to the securable compartment 114, and the securable compartment 114 is prevented from allowing access (e.g. the door 260 may be kept locked).

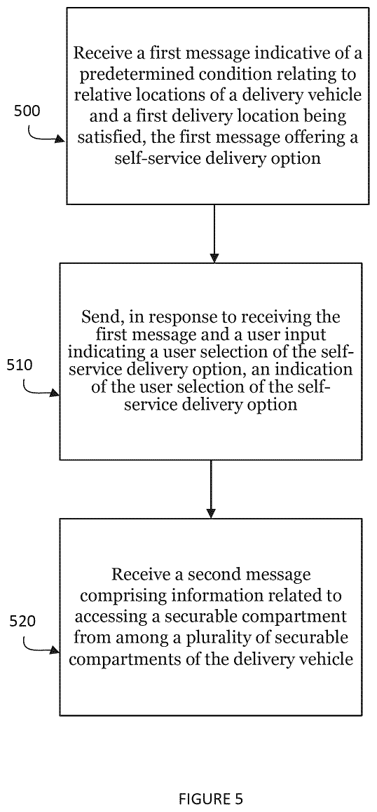

FIG. 5 is a flow chart illustrating an example of a method performed by the user device in the self-service delivery system. As mentioned previously, the self-service delivery system may comprise one or more user devices 120. As such, one or more of the operations may be carried out on a plurality of user devices 120.

At operation 500, the user device 120 receives a first message indicative of a predetermined condition relating to relative locations of a delivery vehicle and a first delivery location being satisfied, the first message offering a self-service delivery option.

A detailed description of the first message has been provided above in relation to FIG. 4, and will not be repeated here.

At operation 510, the user device 120 sends, in response to receiving the first message and a user input indicating a user selection of the self-service delivery option, an indication of the user selection of the self-service delivery option.

The user selection of the self-service delivery option may be received at the user device 120 by way of any means capable of accepting a user input (e.g. a physical button, a touch display, a microphone, a camera, etc.). For instance, the user input may be an activation of a physical button, tapping a touch display, a voice command, a gesture, etc.

At operation 520, the user device 120 receives a second message comprising information related to accessing a securable compartment from among a plurality of securable compartments of the delivery vehicle.

A detailed description of the second message has been provided above in relation to FIG. 4, and will not be repeated here.

The method illustrated in FIG. 5 may further comprise the operations of, responsive to determining that the securable compartment is proximal, sending at least some of the received information related to accessing the securable compartment.

The determination that the securable compartment 114 is proximal may be based on sensor data from a sensor of the user device 120 (e.g. from a camera, a proximity sensor, a LIDAR sensor, etc.). Additionally or alternatively, the determination may be based on receiving signals from the securable compartment 114 (e.g. receiving signals indicative of a radio frequency (RF) field for NFC or RFID communications, receiving Bluetooth or Wi-Fi transmissions, etc.). The determination may also be based on a determined location of the vehicle 110 and a determined location of the user device 120 (e.g. with GNSS).

Sending at least some of the received information related to accessing the securable compartment 114 may comprise sending authentication information received in the second message. In some examples, the authentication information is accessible to the user device 120 without having been received from the second message (e.g. stored on the device, downloaded from a website or an app, etc.). The received information may be sent via any suitable protocol or technology (e.g. Wi-Fi, Bluetooth, ZigBee, RFID, NFC, SMS, etc.). The received information may be sent to, for instance, the securable compartment 114, the vehicle 110, and/or the servers 130.

As an example, the user device 120 detects that it is within range of NFC communications with the securable compartment 114. Responsive to this determination, the user device 120 sends, via NFC communications, a code received in the second message previously sent to the user. This code can then be compared to the one sent to the user in the second message, and if it is determined that they match, the securable compartment 114 is unlocked for the user.

In some examples, the user may provide an indication of selection of a self-service delivery option when ordering the item and/or the item may be loaded into the securable compartment 114 of the delivery vehicle 110 before the delivery vehicle 110 has set off on a delivery route (e.g. at the depot). In these examples, operations 400, 430, and/or 500 may be omitted. Furthermore, in these examples, an item associated with a user is loaded into a securable compartment from among plural securable compartments associated with a delivery vehicle (e.g. at the depot); the delivery vehicle is configured to (i) be human operable and (ii) not carry additional passengers; the delivery vehicle is caused to travel to a delivery location associated with the user (e.g. as discussed above in relation to FIGS. 3 to 5); and the securable compartment containing the item associated with the user is caused to allow collection of the item by the user (e.g. as discussed in relation to FIGS. 2B, 4 and 5).

FIG. 6 is a schematic illustration of an example configuration of a computer system 600 which may be utilised to provide one or more of the operations described herein. For instance, the user device(s) 120, the one or more computer systems of vehicle 110 and/or the servers 130 may comprise one or more computer systems 600.

In the example illustrated in FIG. 6, computer system 600 comprises one or more processors 610 communicatively coupled with one or more storage device(s) 630, a network interface 630, and one or more input and/or output devices 640 via an I/O interface 620.

The network interface 630 allows for wireless communications with one or more other computer systems. For instance, computer system 600 of the vehicle 110 can communicate with a computer system of the user device(s) 120 and/or the server(s) 130 via their respective network interfaces 630.

The one or more input and output device(s) 640 allow for the computer system 600 to interface with the outside world. Examples of input devices include user input devices (e.g. a button-type electrical switch, a rocker switch, a toggle switch, a microphone, a camera, etc.), sensors, microphones, cameras, wired communications input, receivers, etc. Examples of output devices include displays, lights, speakers, wired communication output, etc.

The computer system 600 comprises one or more processors 610 communicatively coupled with one or more storage devices 630. The storage device(s) 630 has computer readable instructions stored thereon which, when executed by the processors 610 causes the computer system 600 to cause performance of various ones of the operations described with reference to FIGS. 1 to 5. The computer system 600 may, in some instances, be referred to as simply “apparatus”.

The processor(s) 610 may be of any suitable type or suitable combination of types. Indeed, the term “processor” should be understood to encompass computers having differing architectures such as single/multi-processor architectures and sequencers/parallel architectures. For example, the processor 610 may be a programmable processor that interprets computer program instructions and processes data. The processor(s) 610 may include plural programmable processors.

Alternatively, the processor(s) 610 may be, for example, programmable hardware with embedded firmware. The processor(s) 610 may alternatively or additionally include one or more specialised circuit such as field programmable gate arrays FPGA, Application Specific Integrated Circuits (ASICs), signal processing devices etc. In some instances, the processor(s) 610 may be referred to as computing apparatus or processing means.

The processor(s) is coupled to the storage device(s) 630 and is operable to read/write data to/from the storage device(s) 630. The storage device(s) 630 may comprise a single memory unit or a plurality of memory units, upon which the computer readable instructions (or code) is stored. For example, the storage device(s) 630 may comprise both volatile memory and non-volatile memory. In such examples, the computer readable instructions/program code may be stored in the non-volatile memory and may be executed by the processor(s) 610 using the volatile memory for temporary storage of data or data and instructions. Examples of volatile memory include RAM, DRAM, and SDRAM etc. Examples of non-volatile memory include ROM, PROM, EEPROM, flash memory, optical storage, magnetic storage, etc.

The storage device(s) 630 may be referred to as one or more non-transitory computer readable memory medium. Further, the term ‘memory’, in addition to covering memory comprising both one or more non-volatile memory and one or more volatile memory, may also cover one or more volatile memories only, one or more non-volatile memories only. In the context of this document, a “memory” or “computer-readable medium” may be any media or means that can contain, store, communicate, propagate or transport the instructions for use by or in connection with an instruction execution system, apparatus, or device, such as a computer.

The computer readable instructions/program code may be pre-programmed into the computer system 600. Alternatively, the computer readable instructions may arrive at the computer system 600 via an electromagnetic carrier signal or may be copied from a physical entity such as a computer program product, a memory device or a record medium such as a CD-ROM or DVD. The computer readable instructions may provide the logic and routines that enables the computer system 600 to perform the functionality described above. The combination of computer-readable instructions stored on storage device(s) may be referred to as a computer program product. In general, references to computer program, instructions, code etc. should be understood to express software for a programmable processor firmware such as the programmable content of a hardware device as instructions for a processor or configured or configuration settings for a fixed function device, gate array, programmable logic device, etc.

Although various aspects of the methods and apparatuses described herein are set out in the independent claims, other aspects may comprise other combinations of features from the described embodiments and/or the dependent claims with the features of the independent claims, and not solely the combinations explicitly set out in the claims.

It is also noted herein that while the above describes various examples, these descriptions should not be viewed in a limiting sense. Rather, there are several variations and modifications which may be made without departing from the scope of the present invention as defined in the appended claims. The extent of protection is defined by the following claims, with due account being taken of any element which is equivalent to an element specified in the claims.

1. Method for enabling self-service delivery, comprising:
responsive to determining that a first predetermined condition relating to relative locations of a delivery vehicle and a first delivery location is satisfied, sending, to a user associated with the first delivery location, a first message offering a self-service delivery option;
receiving, from the user in response to the first message, an indication of a user selection of the self-service delivery option;
responsive to receiving the indication:
sending, to the user, a second message comprising information relating to accessing a securable compartment from among plural securable compartments associated with the delivery vehicle; and
issuing a message to cause an item associated with the user to be loaded into the securable compartment.

2. The method of claim 1, further comprising:
determining that a second predetermined condition relating to relative locations of the first delivery location and a second delivery location is satisfied; and
responsive to determining that the second predetermined condition is satisfied, sending, to the user associated with the first delivery location, a third message comprising data indicative of a collection location.

3. The method of claim 2, further comprising:
causing the delivery vehicle to remain stationary proximal to the first delivery location or the second delivery location until it has been determined that the item associated with the user has been removed from the securable compartment.

4. The method of claim 2, further comprising:
causing the delivery vehicle to autonomously travel from the second delivery location towards the first delivery location; and
responsive to a third predetermined condition relating to relative locations of the delivery vehicle and the user and/or the first delivery location being satisfied, causing the delivery vehicle to park and remain stationary until it has been determined that the item associated with the user has been removed from the securable compartment.

5. The method of any one of the preceding claims, further comprising:
receiving a request to allow access to the securable compartment; and
causing the securable compartment to allow access.

6. The method of claim 5, wherein the information providing access to the securable compartment comprises authentication information associated with the user.

7. The method of claim 5, further comprising accessing stored authentication information associated with the user.

8. The method of claims 6 or 7, wherein receiving the request to allow access to the securable compartment comprises:
receiving authentication information; and
determining that the received authentication information matches the authentication information associated with the user.

9. The method of claim 8, further comprising:
responsive to determining that the received authentication information does not match the authentication information associated with the user, preventing the securable compartment from allowing access.

10. The method of any one of claims 5 to 9, wherein allowing access to the securable compartment comprises at least one of: opening a door of the securable compartment, unlocking a door of the securable compartment, and dispensing an item associated with the user.

11. The method of any preceding claim, wherein issuing the message to cause the item associated with the user to be loaded into the securable compartment comprises:
providing an instruction, to an operator of the delivery vehicle, to load the item associated with the user into the securable compartment.

12. The method of any preceding claim, comprising a determination step wherein if it is determined that there is no available suitable securable compartment on the vehicle for the item to be loaded into, the first message offering a self-service delivery option is not sent.

13. The method of any preceding claim, wherein the message to cause an item associated with the user to be loaded into the securable compartment is issued to a means for autonomously loading the item into the securable compartment.

14. Method performed by one or more user devices of a user associated with a first delivery location in a self-service delivery process, the method comprising:
receiving a first message indicative of a predetermined condition relating to relative locations of a delivery vehicle and a first delivery location being satisfied, the first message offering a self-service delivery option;
sending, in response to receiving the first message and a user input indicating a user selection of the self-service delivery option, an indication of the user selection of the self-service delivery option; and
receiving a second message comprising information relating to accessing a securable compartment from among a plurality of securable compartments of the delivery vehicle.

15. The method of claim 14, further comprising:
responsive to determining that the securable compartment is proximal, sending at least some of the received information relating to accessing the securable compartment.

16. A method comprising:
causing an item associated with a user to be loaded into a securable compartment from among plural securable compartments associated with a delivery vehicle, the delivery vehicle being configured to (i) be human operable and (ii) not carry additional passengers;
causing the delivery vehicle to travel to a delivery location associated with the user;
causing the securable compartment to allow collection of the item by the user.

17. A delivery vehicle comprising one or more securable compartments for containing an item to be delivered, the delivery vehicle comprising means to perform the method of any of claims 1 to 13.

18. A user device comprising means to perform the method of claim 14 or claim 15.

19. A computer-readable storage medium comprising instructions which, when executed by one or more processors, cause the one or more processors to perform the method of any of claims 1 to 13; or claims 14 or 15; or claim 16.

20. A system comprising means to perform the method of any of claims 1 to 16.
